(19) United States
(12) Patent Application Publication
(10) Pub. No.: US 2022/0188751 A1
(43) Pub. Date: Jun. 16, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Takuma SUZUKI, Tokyo (JP); Kimihiko ISOBE, Kanagawa (JP)

(73) Assignee: FUJIFILM Business Innovation Corp., Tokyo (JP)

(21) Appl. No.: 17/338,684

(22) Filed: Jun. 4, 2021

(30) Foreign Application Priority Data
Dec. 11, 2020 (JP) 2020-206238

(51) Int. Cl. G06Q 10/08; H04N 1/00

(52) U.S. Cl. CPC G06Q 10/087; G06Q 10/083; H04N 1/00145

(57) ABSTRACT

An information processing apparatus includes a processor configured to: obtain an index value representing an operating status of a production facility for a product at each of plural order-receiving companies registered in advance as candidates for a contractor for production of the product; for each order-receiving company, set an order-receiving condition of at least one of an estimated amount and a delivery time for production of the product in accordance with the index value; and output estimate order-receiving conditions of each order-receiving company, which include the order-receiving condition, to an order-placing terminal used by a person in charge at a company that places an order for the product.

### CROSS-REFERENCE TO RELATED APPLICATIONS

This application is based on and claims priority under 35 USC 119 from Japanese Patent Application No. 2020-206238 filed Dec. 11, 2020.

### BACKGROUND

### (i) Technical Field

The present disclosure relates to an information processing apparatus and a non-transitory computer readable medium.

### (ii) Related Art

Japanese Unexamined Patent Application Publication No. 2019-61635 discloses the following system. In this system, a company wishing to place an order registers its company name, contact address, request contents, request time, budget, facilities, environmental conditions, and required qualifications in a server through the Internet. A company wishing to receive an order registers its company name, contact address, facilities owned, work environment, number of workers, required qualifications, licenses, and details of a job that the company is good at, as well as its vacant time or scheduled vacant time in the server. In doing so, the server matches the registered information of the company wishing to place an order and the registered information of the company wishing to receive an order, and, as a result of the matching, transmits information on the company wishing to receive an order to the company wishing to place an order and information on the company wishing to place an order to the company wishing to receive an order.

Japanese Unexamined Patent Application Publication No. 2006-172201 discloses an optimal supplier selecting system including a server to which a terminal(s) at one or more printing requesters and terminals at multiple printing companies are connectable via a network. The server performs a process of mediating the placement and reception of an order for printing between a printing requester and a printing company. The server includes the following: an order-reception desired condition collecting unit that collects an order-reception desired condition from a terminal at a printing company terminal; a memory that stores the order-reception desired condition; an order-reception desired condition registering unit that configures a database in which order-reception desired conditions stored in the memory are reorganized by certain types; an order-placement condition receiving unit that receives an order-placement condition regarding printing requested by a printing requester, which is transmitted from a terminal at the printing requester; a search unit that searches the reorganized database to find a combination of a printing company that satisfies the order-placement condition, and a number of prints and a print type to be undertaken by the printing company; and an order placing unit that transmits information regarding a result of the combination found by the search unit to the printing requester, and receives approval information transmitted from the printing requester in accordance with the information regarding the result of the combination.

In order for an order-receiving company that receives a request for producing a product from an order-placing company to suppress variations in the operating status of producing facilities, the order-receiving company may vary an order-receiving condition presented to the order-placing company on the basis of the product order-reception status.

Hitherto, a person in charge at the order-receiving company has confirmed the product order-reception status, and, for a production request in a period when the operating rate of the producing facilities is lower than a target operating rate, has set an order-receiving condition that is more favorable to the order-placing company than a standard order-receiving condition. In contrast, the person in charge at the order-receiving company has set, for a production request in a period when the operating rate of the producing facilities is higher than the target operating rate, an order-receiving condition that is more unfavorable to the order-placing company than the standard order-receiving condition.

However, it takes time and labor for the person in charge at the order-receiving company to, for every request for producing a product, take into consideration the product order-reception status and set the order-receiving condition to be presented to the order-placing company. If the number of production requests from one or more order-placing companies increases, the person in charge at the order-receiving company becomes very busy setting the order-receiving condition.

### SUMMARY

Aspects of non-limiting embodiments of the present disclosure relate to providing an information processing apparatus and a non-transitory computer readable medium for reducing the effort required to set an order-receiving condition, as compared to the case in which a person in charge at an order-receiving company that receives a request for producing a product from an order-placing company takes into consideration its order-receiving status and sets an order-receiving condition to be presented to the order-placing company in order to adjust orders for products.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: obtain an index value representing an operating status of a production facility for a product at each of a plurality of order-receiving companies registered in advance as candidates for a contractor for production of the product; for each order-receiving company, set an order-receiving condition of at least one of an estimated amount and a delivery time for production of the product in accordance with the index value; and output estimate order-receiving conditions of each order-receiving company, which include the order-receiving condition, to an order-placing terminal used by a person in charge at a company that places an order for the product.

### BRIEF DESCRIPTION OF THE DRAWINGS

An exemplary embodiment of the present disclosure will be described in detail based on the following figures, wherein:

FIG. 1 is a diagram illustrating an example of the configuration of an ordering system;

FIG. 2 is a diagram illustrating an example of production facility information;

FIG. 3 is a diagram illustrating an example of the association among an order-receiving company, equipment, and a manageable item based on the production facility information;

FIG. 4 is a diagram illustrating an example of standard estimate information;

FIG. 5 is a diagram illustrating an example of manageable-item information;

FIG. 6 is a diagram illustrating an example of a busy/idle setting screen;

FIG. 7 is a diagram illustrating an example of the configuration of ordered printed matter, and the steps of producing the printed matter;

FIG. 8 is a diagram illustrating an example of the configuration of a main portion of an electrical system of an information processing apparatus;

FIG. 9 is a flowchart illustrating an example of the flow of an updating process executed by a central processing unit (CPU) of the information processing apparatus;

FIG. 10 is a diagram illustrating an example of an operation calendar;

FIG. 11 is a flowchart illustrating an example of the flow of an order receiving process executed by the CPU of the information processing apparatus; and

FIG. 12 is a diagram illustrating an example of estimate order-receiving conditions.

### DETAILED DESCRIPTION

Hereinafter, an exemplary embodiment will be described with reference to the drawings. Note that the same elements and the same processes are given the same reference numerals throughout the drawings, and overlapping descriptions are omitted.

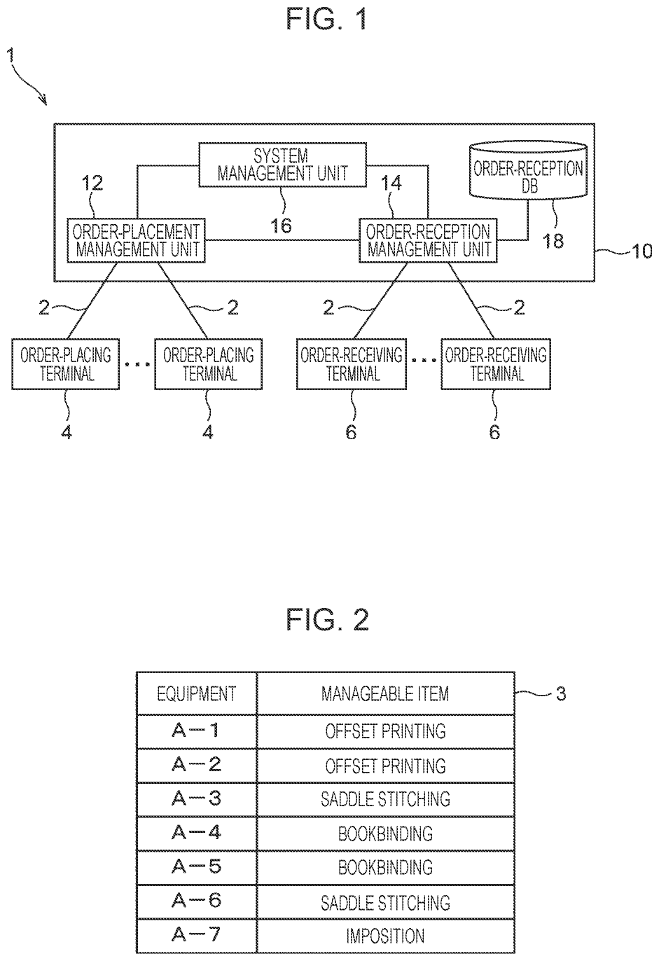

FIG. 1 is a diagram illustrating an example of the configuration of an ordering system 1 according to the present exemplary embodiment. Products handled in the ordering system 1 are not particularly limited in their type, as long as they are products whose manufacturing starts after receiving orders. In addition, the products here include not only tangible items but also intangible items such as design data.

Hereinafter, for example, the ordering system 1 which receives an order from an order-placing company for printed matter, such as a book or a pamphlet, and, in order for the printed matter to be produced by an order-receiving company designated by the order-placing company from among a plurality of presented order-receiving companies, mediates between the order-placing company and the order-receiving company.

As illustrated in FIG. 1, the ordering system 1 includes order-placing terminals 4 located at order-placing companies, order-receiving terminals 6 located at order-receiving companies, and an information processing apparatus 10 connected to the order-placing terminals 4 and the order-receiving terminals 6 via communication lines 2. The communication lines 2 are not limited in their type. The communication lines 2 may be wired or wireless, or may be dedicated lines or public lines.

The information processing apparatus 10 includes functional units including an order-placement management unit 12, an order-reception management unit 14, and a system management unit 16, and an order-reception database (DB) 18.

The order-placement management unit 12 receives an order for printed matter from each order-placing terminal 4, and outputs estimate order-receiving conditions, which are order-receiving conditions for an order-receiving company capable of producing the printed matter satisfying a required specification indicated in the order to receive the order, to the order-placing terminal 4. A person in charge at the order-placing company refers to the estimate order-receiving conditions of each order-receiving company, which are output to the order-receiving terminal 4, and outputs designation information that designates, from among order-receiving companies presented by the information processing apparatus 10, an order-receiving company requested to produce the printed matter (referred to as an “order-receiving company in charge”) to the order-placement management unit 12.

Estimate order-receiving conditions output by the order-placement management unit 12 to the order-placing terminal 4 are set by the order-reception management unit 14.

Outputting estimate order-receiving conditions to the order-placing terminal 4 is making the estimate order-receiving conditions recognizable by a person in charge at the order-placing company through the order-placing terminal 4. This includes forms such as displaying the estimate order-receiving conditions on a screen of the order-placing terminal 4, reporting the estimate order-receiving conditions by voice, printing the estimate order-receiving conditions on paper using an image forming apparatus, and storing the estimate order-receiving conditions in a storage device. Here, an example in which, in response to an output of estimate order-receiving conditions from the order-placement management unit 12 to the order-placing terminal 4, the estimate order-receiving conditions are displayed on the screen of the order-placing terminal 4 will be described by way of example.

On receipt of an order from an order-placing company from the order-placement management unit 12, the order-reception management unit 14 obtains a required specification of printed matter included in the order, and selects, from among a plurality of order-receiving companies that are examples of pre-registered production contractor candidates, one or more order-receiving companies capable of producing the printed matter satisfying the required specification (referred to as “specific order-receiving companies”).

Moreover, the order-reception management unit 14 sets, for each of the specific order-receiving companies, estimate order-receiving conditions of the requested printed matter on the basis of registered information registered in advance in the information processing apparatus 10 by each of the order-receiving companies including each of the specific order-receiving companies, and reports the estimate order-receiving conditions to the order-placement management unit 12. Registered information registered by each order-receiving company is stored in the order-reception DB 18.

Registered information registered in advance by each order-receiving company in the information processing apparatus 10 includes information for the information processing apparatus 10 to select a specific order-receiving company for an order from an order-placing company, and to set estimate order-receiving conditions. Specifically, the registered information includes production facility information 3, standard estimate information 5, and manageable-item information 7.

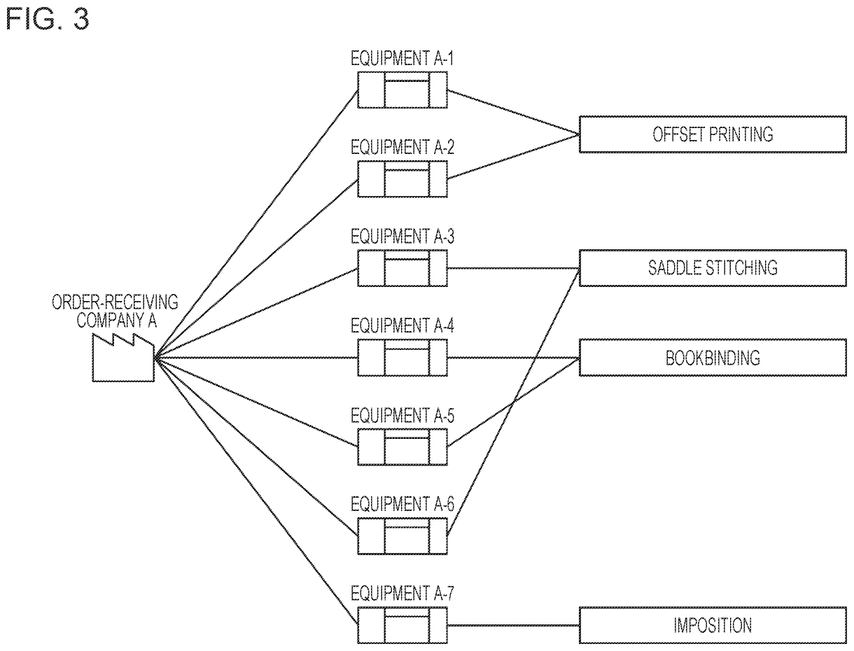

FIG. 2 is a diagram illustrating an example of the production facility information 3. As illustrated in FIG. 3, the production facility information 3 is information that associates the type of equipment, which is an example of a production facility owned by an order-receiving company for producing printed matter, and a manageable item that may be managed by the equipment. Although FIG. 2 illustrates an example of the production facility information 3 of a particular order-receiving company (order-receiving company A), there is the production facility information 3 for every order-receiving company.

The production facility information 3 illustrated in FIG. 2 indicates that the order-receiving company A owns seven pieces of equipment A-1 to A-7, and is capable of managing the steps of offset printing, saddle stitching, bookbinding, and imposition. In addition, the production facility information 3 indicates that the pieces of equipment A-1 and A-2 are used for offset printing, the pieces of equipment A-3 and A-6 are used for saddle stitching, the pieces of equipment A-4 and A-5 are used for bookbinding, and the piece of equipment A-7 is used for imposition.

FIG. 3 is a diagram illustrating an example of the association among an order-receiving company, equipment, and a manageable item based on the production facility information 3 illustrated in FIG. 2.

In the case of selecting a specific order-receiving company from among a plurality of order-receiving companies, the order-reception management unit 14 refers to the production facility information 3 and selects a combination of an order-receiving company that owns equipment capable of managing a required specification indicated in the order, and to-be-used equipment. For example, in the case where the required specification of the order designates to perform offset printing, the order-reception management unit 14 selects the combinations [order-receiving company A and equipment A-1] and [order-receiving company A and equipment A-2].

As a matter of course, if there is, besides the order-receiving company A, an order-receiving company that owns equipment capable of managing the required specification indicated in the order, the order-reception management unit 14 selects all the order-receiving companies that own equipment capable of managing the required specification indicated in the order as specific order-receiving companies, and selects combinations of each of the selected specific order-receiving companies and equipment used at each of the specific order-receiving companies.

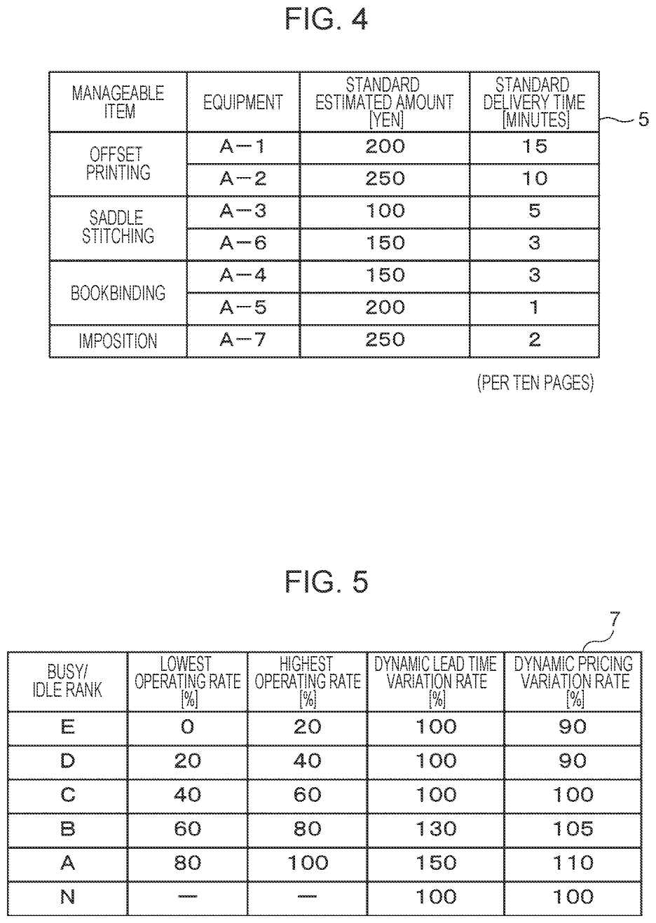

In contrast, FIG. 4 is a diagram illustrating an example of the standard estimate information 5 for a specific order-receiving company (namely, the order-receiving company A).

The standard estimate information 5 includes an estimated amount obtained by adding the profit of the order-receiving company to the manufacturing costs in the case where a manageable item that may be managed by equipment is performed regardless of the operating status of the equipment, that is, the standard estimated amount of printed matter set on the basis of the manufacturing costs absolutely needed to produce the printed matter with the equipment, such as a utility cost, a raw material cost, and a depreciation expense.

In addition, the standard estimate information 5 includes a period required in the case where a manageable item is performed with equipment regardless of the operating status of the equipment, that is, the standard delivery time of printed matter set from the processing capacity of the equipment.

Because both the standard estimated amount and the standard delivery time change depending on the number of pages of order-received printed matter, the standard estimated amount and the standard delivery time in the standard estimate information 5 illustrated in FIG. 4 indicate the standard estimated amount and the standard delivery time per unit number of pages (such as ten pages).

Although the standard estimate information 5 has been described here using the standard estimate information 5 of the order-receiving company A by way of example, there is the standard estimate information 5 for every order-receiving company.

The order-reception management unit 14 varies the standard estimated amount and the standard delivery time, which are indicated in the standard estimate information 5, in accordance with the operating status of equipment, and sets estimate order-receiving conditions to be output to the order-placing terminal 4.

The operating status of equipment is represented by an index value indicating the degree of how busy or idle the equipment is, such as how much the equipment is used for producing printed material. The index value is not limited in its type, as long as it represents the degree of how busy or idle each piece of equipment is. For example, the operating rate of equipment, the power consumption of equipment per day, or the number of pages of printed matter to be processed by equipment per day may be used. Hereinafter, an example in which the operating rate of equipment is used as the index value indicating the degree of how busy or idle the equipment is will be described by way of example.

The operating rate of equipment refers to, for example, the ratio of the time in which the equipment is used for producing printed matter out of 24 hours a day. As a matter of course, the denominator of the operating rate may be set not in units of days, but in units of hours, weeks, or months. That is, the operating rate of equipment represents how busy or idle the equipment is in each period adopted as the denominator of the operating rate.

To set estimate order-receiving conditions in accordance with the operating rate of equipment at each order-receiving company, the order-reception management unit 14 obtains the operating rate of each piece of equipment from each order-receiving company. The order-reception management unit 14 may obtain the operating rate of each piece of equipment from the order-receiving terminal 6 located at predetermined intervals at each order-receiving company, or may obtain the operating rate of each piece of equipment in conjunction with the occurrence of a specific event, such as the case where an order is reported from the order-placement management unit 12.

The operating rate of equipment may be obtained by the so-called polling process, which is the process of transmitting the operating rate from each order-receiving terminal 6 in response to a request from the order-reception management unit 14. Alternatively, even if there is no request from the order-reception management unit 14, if, for example, there is a change in the operating rate of equipment, each order-receiving terminal 6 may voluntarily transmit the changed operating rate of the equipment to the order-reception management unit 14.

The order-reception management unit 14, which has obtained the operating rate of each piece of equipment from each order-receiving company as above, refers to the manageable-item information 7 and sets estimate order-receiving conditions.

FIG. 5 is a diagram illustrating an example of the manageable-item information 7, which illustrates, for example, the manageable-item information 7 of the order-receiving company A. As illustrated in FIG. 5, the manageable-item information 7 includes pieces of information on the busy/idle rank, the lowest operating rate, the highest operating rate, the dynamic lead time fluctuation rate, and the dynamic pricing fluctuation rate.

The busy/idle rank is information that represents how busy equipment is by classifying into categories, and there are busy/idle ranks A to E and N.

The lowest operating rate and the highest operating rate are items of information that define the range of the operating rate of equipment corresponding to each of the busy/idle ranks. According to the manageable-item information 7 illustrated in FIG. 5, if the operating rate is greater than or equal to 0% and less than 20%, the busy/idle rank is classified as rank E; and, if the operating rate is greater than or equal to 20% and less than 40%, the busy/idle rank is classified as rank D. Similarly, if the operating rate is greater than or equal to 40% and less than 60%, the busy/idle rank is classified as rank C; and, if the operating rate is greater than or equal to 60% and less than 80%, the busy/idle rank is classified as rank B. In addition, if the operating rate is greater than or equal to 80% and less than or equal to 100%, the busy/idle rank is classified as rank A.

The busy/idle rank being N rank means that a process of varying the order-receiving condition in accordance with the operating rate of equipment is not performed. The operating rate of equipment given the designation of N rank from the order-receiving terminal 6 is classified as rank N at all times, regardless of the magnitude of the operating rate.

The dynamic lead time fluctuation rate is information that defines, for each busy/idle rank, the fluctuation rate with respect to the standard delivery time of a manageable item manageable by the equipment.

The dynamic pricing fluctuation rate is information that defines, for each busy/idle rank, the fluctuation rate with respect to the standard estimated amount in the case where a manageable item manageable by the equipment is performed.

It is represented that, as the operating rate of equipment decreases, orders for printed matter are decreasing. In such a case, for example, in order to secure sales, the order-receiving company may want to receive orders from order-placing companies even by performing either or both of setting the estimated amount of printed matter to be less than the standard estimated amount and setting the delivery time of printed matter to be shorter than the standard delivery time.

In contrast, it is represented that, as the operating rate of equipment increases, orders for printed matter are increasing. In such a case, for example, because it becomes difficult to adjust personnel and the like, the order-receiving company may want to reduce new orders from order-placing companies even by performing either or both of setting the estimated amount of printed matter to be higher than the standard estimated amount and setting the delivery time of printed matter to be longer than the standard delivery time.

The dynamic lead time fluctuation rate and the dynamic pricing fluctuation rate function as coefficients for adjusting this supply and demand balance.

For example, equipment classified as the busy/idle rank E is equipment classified as a rank with the lowest operating rate among the busy/idle ranks defined in the manageable-item information 7. In the example of the manageable-item information 7 illustrated in FIG. 5, for equipment classified as the busy/idle rank E, the dynamic lead time fluctuation rate is set to 100, while the dynamic pricing fluctuation rate is set to 90%. Therefore, the delivery time for an order per unit number of pages of printed matter using equipment classified as the busy/idle rank E is calculated using the standard delivery time, while the estimated amount is calculated using a reduced amount obtained by multiplying the standard estimated amount by 0.9 times. That is, the order-reception management unit 14 sets estimate order-receiving conditions on the basis of an estimated amount lower than the standard estimated amount.

In contrast, equipment classified as the busy/idle rank A is equipment classified as a rank with the highest operating rate among the busy/idle ranks defined in the manageable-item information 7. In the example of the manageable-item information 7 illustrated in FIG. 5, for equipment classified as the busy/idle rank A, the dynamic lead time fluctuation rate is set to 150%, while the dynamic pricing fluctuation rate is set to 110%. Therefore, the delivery time for an order per unit number of pages of printed matter using equipment classified as the busy/idle rank A is set to a delivery time obtained by multiplying the standard delivery time by 1.5 times, and the estimated amount is set to an amount obtained by multiplying the standard estimated amount by 1.1 times. That is, the order-reception management unit 14 sets estimate order-receiving conditions on the basis of an estimated amount higher than the standard estimated amount, and a delivery time longer than the standard delivery time.

In this manner, even for orders with the same required specification, the order-reception management unit 14 varies at least one of the order-receiving conditions of the estimated amount and the delivery time in accordance with the operating rate of equipment, and sets the estimate order-receiving conditions. That is, the busy/idle rank is also an example of an index indicating how busy or idle equipment is.

Because the dynamic lead time fluctuation rate and the dynamic pricing fluctuation rate for equipment classified as the busy/idle rank N are each set to 100%, for orders with the same required specification, the order-receiving conditions do not vary depending on how great or small the operating rate of the equipment is.

Although the method of setting the estimate order-receiving conditions has been described using the manageable-item information 7 of the order-receiving company A by way of example in FIG. 5, because there is the manageable-item information 7 for every order-receiving company, the estimate order-receiving conditions of each order-receiving company are set using the manageable-item information 7 of each order-receiving company.

The manageable-item information 7 illustrated in FIG. 5 is transmitted to the order-reception management unit 14 by entering the manageable-item information 7 by a person in charge at each order-receiving company on a busy/idle setting screen 9 displayed on each order-receiving terminal 6 via the communication line 2 by the order-reception management unit 14.

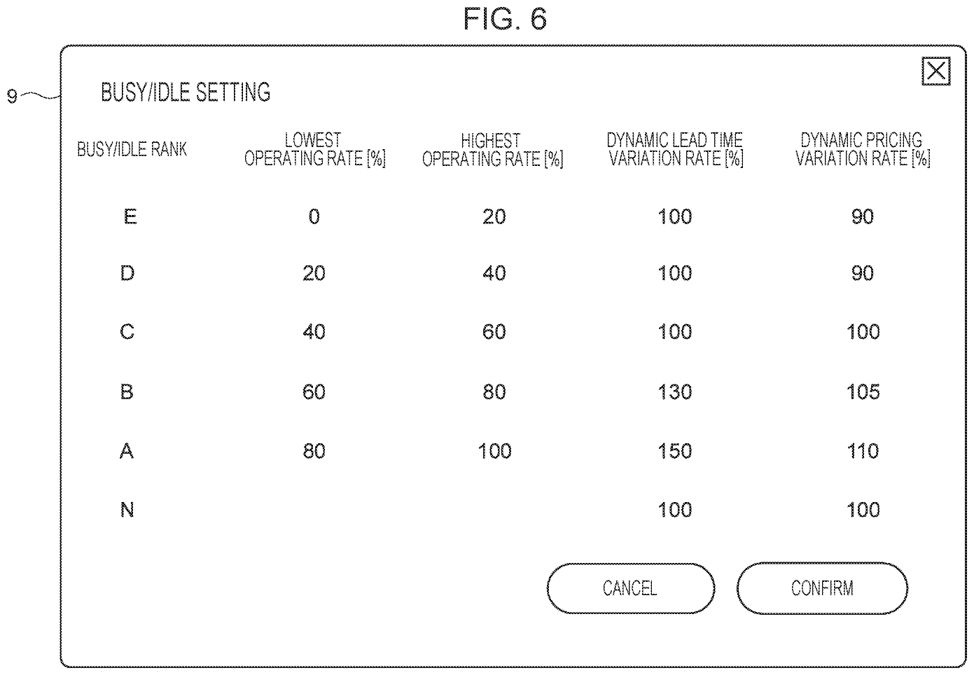

FIG. 6 is a diagram illustrating an example of the busy/idle setting screen 9. As illustrated in FIG. 6, the busy/idle setting screen 9 is provided with an entry area for entering each item of the manageable-item information 7.

Having obtained the manageable-item information 7, the order-reception management unit 14 stores the manageable-item information 7 in units of order-receiving companies in the order-reception DB 18.

Since the update time of the manageable-item information 7 is not limited, whenever the order-reception management unit 14 receives the manageable-item information 7 from an order-receiving terminal 6, the order-reception management unit 14 updates the manageable-item information 7 stored in the order-reception DB 18 with the received manageable-item information 7.

The system management unit 16 in the information processing apparatus 10 in FIG. 1 executes a process of controlling the order-placement management unit 12 and the order-reception management unit 14 described above to allow the order-placement management unit 12 and the order-reception management unit 14 to collaborate in matching an order-placing company and an order-receiving company.

The information processing apparatus 10 stores, as registered information for each pre-registered order-receiving company, information on the type of equipment owned by the order-receiving company, a manageable item that may be managed by each piece of equipment, estimate information that serves as a standard for each piece of equipment, and the busy/idle rank of each piece of equipment. Therefore, the mode is not limited to setting the estimate order-receiving conditions of each order-receiving company, and the estimate order-receiving conditions may be set for each piece of equipment at each order-receiving company.

This means that, besides a collective ordering pattern in which production of printed matter is collectively requested to one order-receiving company, distributed ordering is also supported in which an order for printed matter is placed to different order-receiving companies in units of products, parts, or producing steps.

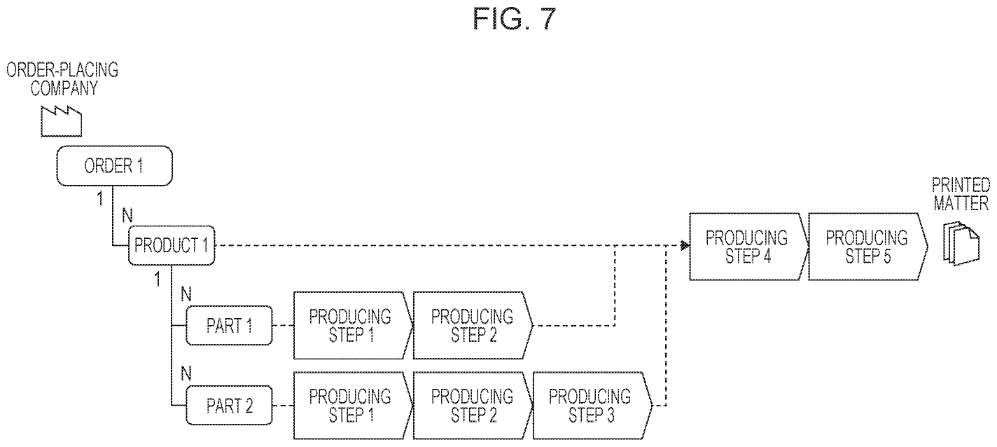

FIG. 7 is a diagram illustrating an example of the configuration of printed matter for which an “order” has been received from an order-placing company, and the steps of producing the printed matter.

In FIG. 7, for example, the symbol “N” at the top left of a frame of “product 1”, “part 1”, “product 2”, and so forth means that there is at least one item in the frame. In addition, the symbol “1” below “order 1” means that “order 1” includes one order.

Therefore, FIG. 7 represents the configuration of printed matter, where one order at least includes one product, and one product at least includes one part. For example, in the case where the product is a book, the cover, text, and strip of the book correspond to the parts of the book.

Furthermore, FIG. 7 indicates that “part 1” is produced through “producing step 1” and “producing step 2”, and “part 2” is produced through “producing step 1”, “producing step 2”, and “producing step 3”. Moreover, it is indicated that the printed matter will be produced by supplying “part 1” and “part 2” to “producing step 4”, and executing “producing step 4” and “producing step 5”. “Producing step 1” to “producing step 5” are producing steps corresponding to, for example, imposition, offset printing, saddle stitching, bookbinding, and inspection, respectively.

In order for the information processing apparatus 10 to output the estimate order-receiving conditions for each piece of equipment that is in charge of each producing step, the following ordering mode becomes possible: a person in charge at the order-placing company places an order for “part 1” and an order for “part 2” to different order-receiving companies, such that an order for “part 1” is placed to the order-receiving company A and an order for “part 2” is placed to an order-receiving company B; and the person in charge further places, from “producing step 4” onward, an order to an order-receiving company C. In addition, even for the same part, the order placing destination may be changed for each producing step, such that, an order for “producing step 1” of “part 1” is placed to the order-receiving company A, and an order for “producing step 2” of “part 1” is placed to the order-receiving company B.

As a matter of course, in the case where there are order-receiving companies capable of receiving orders in units of parts, products, or orders, the information processing apparatus 10 may collectively place orders in units of parts, products, or orders to one order-receiving company.

The information processing apparatus 10 in this ordering system 1 includes a computer 20.

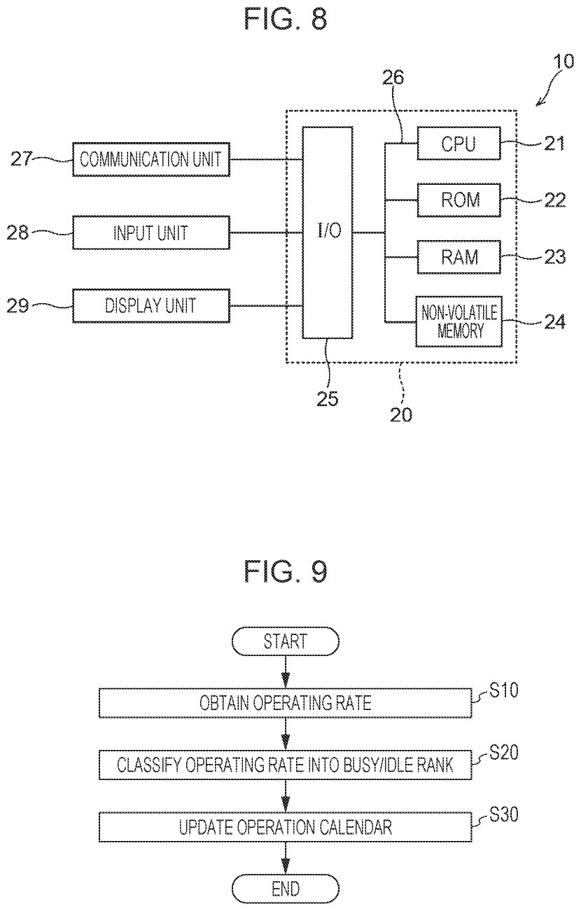

FIG. 8 is a diagram illustrating an example of the configuration of a main portion of an electrical system of the information processing apparatus 10 using the computer 20.

The computer 20 includes a CPU 21, which performs the processing of the functional units of the information processing apparatus 10 illustrated in FIG. 1, read-only memory (ROM) 22, which stores an information processing program, random-access memory (RAM) 23, which is used as a temporary work area for the CPU 21, non-volatile memory 24, and an input/output interface (I/O) 25. The CPU 21, the ROM 22, the RAM 23, the non-volatile memory 24, and the I/O 25 are connected to one another by a bus 26.

The non-volatile memory 24 is an example of a storage device that maintains information stored therein even if power supplied to the non-volatile memory 24 is cut off. For example, semiconductor memory is used as the non-volatile memory 24, but a hard disk drive may also be used. The non-volatile memory 24 need not be included in the computer 20, and, for example, the non-volatile memory 24 may be, like a memory card, a storage device that is attachable to/detachable from the computer 20. For example, the order-reception DB 18 is configured in the non-volatile memory 24, where registered information is stored.

For example, a communication unit 27, an input unit 28, and a display unit 29 are connected to the I/O 25.

The communication unit 27 is connected to the communication lines 2, and includes a communication protocol for communicating with the order-placing terminals 4, the order-receiving terminals 6, and an external apparatus (not illustrated).

The input unit 28 is a device that receives instructions from the operator of the information processing apparatus 10 and reports the instructions to the CPU 21, and, for example, a button, a touchscreen, a keyboard, a pointing device, and a mouse are used.

The display unit 29 is a device that outputs information processed by the CPU 21, and, for example, a display device such as a liquid crystal display, an organic electro-luminescence (EL) display, or a projector that projects an image to a screen is used.

Because the information processing apparatus 10 may be remotely operated via the communication lines 2, the input unit 28 and the display unit 29 are not necessarily essential units of the computer 20, and need not be connected to the I/O 25 depending on the usage.

Next, an updating process of updating the busy/idle status of each order-receiving company will be described.

FIG. 9 is a flowchart illustrating an example of the flow of an updating process executed by the CPU 21 of the information processing apparatus 10 periodically or at a specific time point.

An information processing program that defines the updating process is stored in advance in, for example, the ROM 22 of the information processing apparatus 10. The CPU 21 of the information processing apparatus 10 loads the information processing program stored in the ROM 22, and executes the updating process. It is assumed that the registered information of each order-receiving company is registered in advance in the order-reception DB 18.

In step S10, the CPU 21 obtains the daily operating rate of each piece of equipment for days from the current date from each order-receiving terminal 6 connected to the information processing apparatus 10.

The operating rate of each piece of equipment obtained by the CPU 21 is the operating rate reflecting the operation duration of the equipment required to produce printed matter designated in a received order, regardless of the route of receiving the order. That is, in the case where an order-receiving company may receive orders for printed matter without using the information processing apparatus 10, the operating rate of equipment obtained by the CPU 21 is the operating rate calculated from the operation duration of the equipment operated by orders received by the order-receiving company using the information processing apparatus 10, and the operation duration of the equipment operated by orders received by the order-receiving company without using the information processing apparatus 10.

In step S20, the CPU 21 refers to the manageable-item information 7 stored in the non-volatile memory 24, classifies the operating rate of each piece of equipment obtained in step S10 into a busy/idle rank, and sets the busy/idle rank of each piece of equipment at each order-receiving company.

Instead of using the operating rate of equipment obtained in step S10 as it is and classifying it into a busy/idle rank, the CPU 21 may use the operating rate adjusted by multiplying the obtained operating rate of equipment by a coefficient associated in advance with each piece of equipment and classify the adjusted operating rate into a busy/idle rank. A coefficient associated in advance with each piece of equipment is a coefficient reflecting, for example, the failure rate of the equipment. The higher the failure rate of equipment, the shorter the time devoted by the equipment to produce printed matter. Therefore, if the coefficient is set to be larger than 1 for equipment with a higher failure rate, the operating rate which is more accurate than the operating rate of the equipment calculated only from the received order volume is obtained.

In addition, a coefficient associated in advance with each piece of equipment may be a coefficient reflecting the time required for maintenance. For example, the longer the time required for maintenance of equipment, the shorter the time devoted by the equipment to produce printed matter. Therefore, if the coefficient is set to be larger than 1 for equipment with a longer time required for maintenance, the operating rate which is more accurate than the operating rate of the equipment calculated only from the received order volume may be obtained.

In step S30, the CPU 21 updates an operation calendar 30 on the basis of the busy/idle rank of each piece of equipment at each order-receiving company, which is set in step S20, and ends the updating process illustrated in FIG. 9.

The operation calendar 30 is a schedule table displaying the daily operating rate and busy/idle rank of each piece of equipment at each order-receiving company, and is created for each order-receiving company.

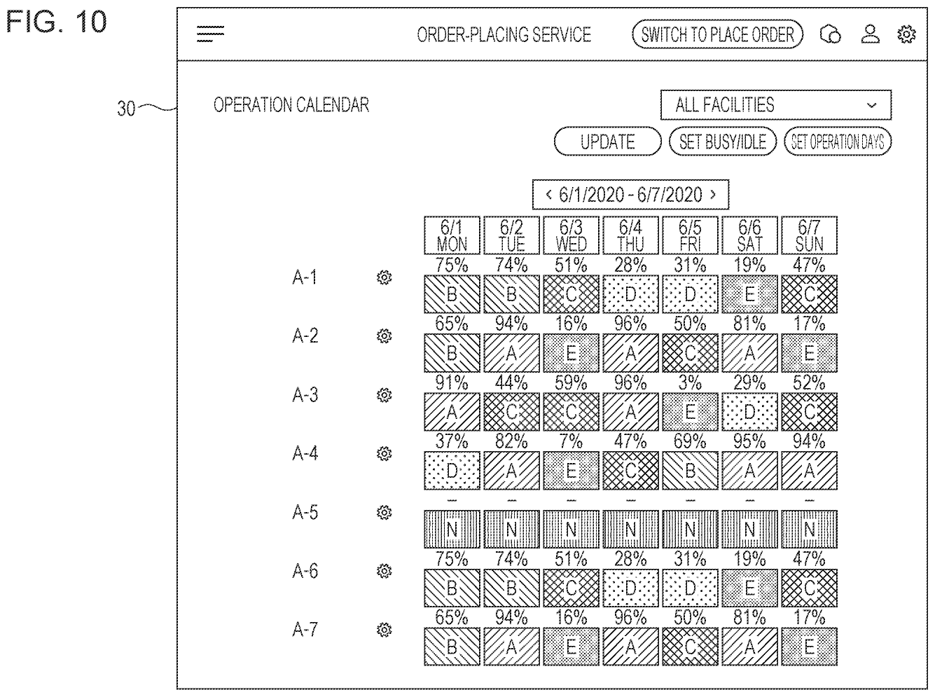

FIG. 10 illustrates an example of the operation calendar 30. In the operation calendar 30, the operating rate and busy/idle rank of each piece of equipment in a designated period are displayed.

On receipt of a request for displaying the operation calendar 30 from an order-receiving terminal 6, the CPU 21 outputs the operation calendar 30 updated in step S30 in FIG. 9 to the order-receiving terminal 6 having made the display request. Accordingly, the operation calendar 30 is displayed on the order-receiving terminal 6, and a person in charge at the order-receiving company checks the busy/idle rank of each piece of equipment at the person's company.

The operation calendar 30 is provided with an “update” button. In the case where the person in charge at the order-receiving company presses the “update” button, the CPU 21 again executes the updating process illustrated in FIG. 9, and updates the operation calendar 30 on the basis of the latest operating rate of each piece of equipment.

In addition, the operation calendar 30 is provided with a “set busy/idle” button and a “set operation days” button. In the case where the person in charge at the order-receiving company presses the “set busy/idle” button, for example, the busy/idle setting screen 9 illustrated in FIG. 6 is displayed on the order-receiving terminal 6, and the person in charge may edit the manageable-item information 7 illustrated in FIG. 5. In the case where the person in charge at the order-receiving company presses the “set operation days” button, the person in charge may set the operation days of the order-receiving company, that is, business days for producing printed matter with equipment.

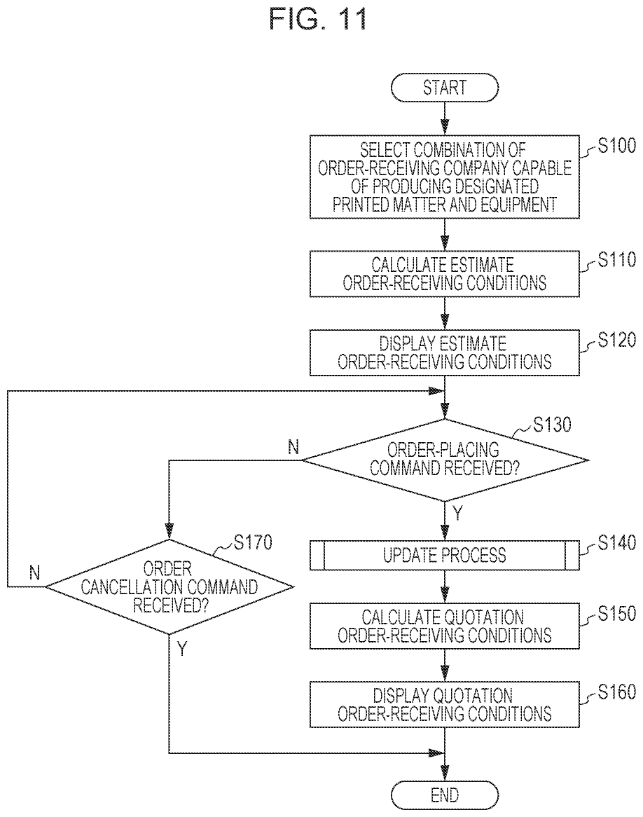

In contrast, FIG. 11 is a flowchart illustrating an example of the flow of an order receiving process executed by the CPU 21 of the information processing apparatus 10 on receipt of an order for printed matter from any order-placing terminal 4.

The order receiving process is also defined by an information processing program. Therefore, the CPU 21 of the information processing apparatus 10 loads the information processing program stored in the ROM 22, and executes the order receiving process. It is assumed that the required specification of an order for printed matter includes the number of pages of the printed matter and the scheduled order placement date. On receipt of an order for printed matter from any order-placing terminal 4, the CPU 21 executes the updating process illustrated in FIG. 9, and then executes the order receiving process illustrated in FIG. 11.

In step S100, the CPU 21 refers to the production facility information 3 stored in the non-volatile memory 24, and selects a combination of an order-receiving company capable of managing a required specification included in the order, that is, a specific order-receiving company, from among a plurality of order-receiving companies, and to-be-used equipment.

In step S110, the CPU 21 refers to the standard estimate information 5 and the manageable-item information 7 stored in the non-volatile memory 24, and the operating rate of each piece of equipment at each order-receiving company, which is obtained in step S10 of the updating process illustrated in FIG. 9, and, from the number of pages of the ordered printed matter and the scheduled order placement date, calculates the estimate order-receiving conditions for each piece of equipment at the specific order-receiving company selected in step S100.

For example, it is assumed that the required specification of the order designates to perform offset printing, the number of pages of the printed matter is 100 pages, and the scheduled order placement date is Jun. 4, 2020.

Since offset printing is designated by the required specification, the CPU 21 refers to the production facility information 3 of the order-receiving company A illustrated in FIG. 2, and, in step S100, selects the combinations [order-receiving company A and equipment A-1] and [order-receiving company A and equipment A-2].

In the standard estimate information 5 in FIG. 4, the standard estimated amount and the standard delivery time per unit number of pages (such as ten pages) of the equipment A-1 are set to 200 yen and 15 minutes, respectively. Therefore, the CPU 21 sets the standard estimated amount and the standard delivery time for the number of pages to be printed (100 pages in this case), which is designated in the required specification, to 2000 yen and 150 minutes, respectively.

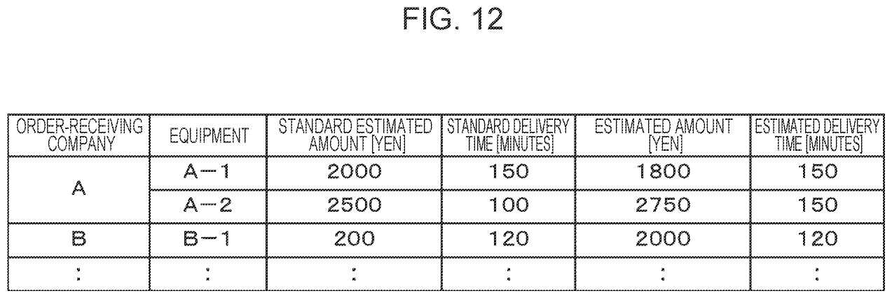

In contrast, as indicated in the operation calendar 30 illustrated in FIG. 10, the busy/idle rank of the equipment A-1 at the order-receiving company A on Jun. 4, 2020 is “D”. Therefore, the CPU 21 calculates, in accordance with the manageable-item information 7 of the order-receiving company A illustrated in FIG. 5, a value obtained by multiplying the standard estimated amount 2000 yen by the dynamic pricing fluctuation rate 90% of the busy/idle rank D, and a value obtained by multiplying the standard delivery time 150 minutes by the dynamic lead time fluctuation rate 100% of the busy/idle rank D, that is, the estimate order-receiving conditions where 1800 yen and 150 minutes are the estimated amount and delivery time, respectively (see FIG. 12).

In addition, in the standard estimate information 5 in FIG. 4, the standard estimated amount and the standard delivery time per unit number of pages (such as ten pages) of the equipment A-2 are set to 250 yen and 10 minutes, respectively. Therefore, the CPU 21 sets the standard estimated amount and the standard delivery time for the number of pages (100 pages in this case) to be printed, which is designated in the required specification, to 2500 yen and 100 minutes, respectively.

In contrast, as indicated in the operation calendar 30 illustrated in FIG. 10, the busy/idle rank of the equipment A-2 at the order-receiving company A on Jun. 4, 2020 is “A”. Therefore, the CPU 21 calculates, in accordance with the manageable-item information 7 of the order-receiving company A illustrated in FIG. 5, a value obtained by multiplying the standard estimated amount 2500 yen by the dynamic pricing fluctuation rate 110% of the busy/idle rank A, and a value obtained by multiplying the standard delivery time 100 minutes by the dynamic lead time fluctuation rate 150% of the busy/idle rank A, that is, the estimate order-receiving conditions where 2750 yen and 150 minutes are the estimated amount and delivery time, respectively (see FIG. 12).

Although the method of calculating the estimate order-receiving conditions by paying attention to the order-receiving company A has been described here, if specific order-receiving companies include an order-receiving company other than the order-receiving company A, the CPU 21 calculates the estimate order-receiving conditions in accordance with the standard estimate information 5, the manageable-item information 7, and the busy/idle rank of equipment at each order-receiving company.

That is, the CPU 21 performs, as the operating rate of equipment becomes higher, at least one of control for varying the estimated amount of printed matter ordered from an order-placing company to be higher than the standard estimated amount, and control for varying the delivery time of the printed matter to be longer than the standard delivery time. Conversely, the CPU 21 performs, as the operating rate of equipment becomes lower, at least one of control for varying the estimated amount of printed matter ordered from an order-placing company to be lower than the standard estimated amount, and control for varying the delivery time of the printed matter to be shorter than the standard delivery time.

Continuously, in step S120 in FIG. 11, the CPU 21 outputs the estimate order-receiving conditions for each piece of equipment at each specific order-receiving company, which are calculated in step S110, to the order-placing terminal 4 having transmitted the order for the printed matter, and displays the estimate order-receiving conditions on the order-placing terminal 4.

Having checked the estimate order-receiving conditions of the ordered printed matter, a person in charge at the order-placing company selects a combination of, from among the specific order-receiving companies, an order-receiving company to be officially requested to produce the printed matter, that is, an order-receiving company in charge, and equipment, and transmits, from the order-placing terminal 4 to the information processing apparatus 10, an order-placing command that designates the order-receiving company in charge as a destination requested to produce the printed matter. Note that the order-placing command includes designation of equipment to be used at the order-receiving company in charge.

In contrast, the CPU 21 of the information processing apparatus 10 determines, in step S130, whether an order-placing command has been received from the order-placing terminal 4. On receipt of an order-placing command, the process proceeds to step S140.

In step S140, the CPU 21 executes the busy/idle status updating process, which is illustrated in FIG. 9, and obtains the latest operating rate of each piece of equipment at each order-receiving company. In this case, the CPU 21 may only obtain the operating rate of equipment at the order-receiving company in charge, which is designated by the order-placing command.

In step S150, the CPU 21 executes processing similar to that in step S110 using the operating rate of equipment at the order-receiving company in charge, which is obtained in step S140, and calculates order-receiving conditions in the case where the printed matter is produced using equipment at the order-receiving company in charge, which is designated by the order-placing command, that is, quotation order-receiving conditions.

In step S160, the CPU 21 outputs the quotation order-receiving conditions calculated in step S150 to the order-placing terminal 4 having transmitted the order-placing command, and reports that the order is confirmed with the output quotation order-receiving conditions. Accordingly, the order receiving process illustrated in FIG. 11 ends.

In contrast, if it is determined in the determination process in step S130 that no order-placing command has been received, the process proceeds to step S170.

In step S170, the CPU 21 determines whether a command to cancel the order has been received from the order-placing terminal 4, which is the destination to which the estimate order-receiving conditions are output.

If no command to cancel the order has been received, it is conceivable that the order-placing company is considering the order-receiving company in charge. Thus, the process proceeds to step S130, and continuously monitors reception of an order-placing command. In contrast, if a command to cancel the order has been received, the order is invalidated. Accordingly, the order receiving process illustrated in FIG. 11 ends.

According to the information processing apparatus 10 according to the present exemplary embodiment, the estimate order-receiving conditions including at least one of the estimated amount and the delivery time varied in accordance with the index value representing the operating status of equipment are output to the order-placing terminal 4.

Here, an example in which the CPU 21 varies the standard estimated amount and the standard delivery time, which are determined in advance for each piece of equipment, in accordance with the operating rate of each piece of equipment and the manageable-item information 7 has been described by way of example. However, the example of setting the estimate order-receiving conditions by varying at least one of the estimated amount and the delivery time of the ordered printed matter in accordance with the operating rate of equipment is not limited to the above-discussed example.

For example, for each busy/idle rank, the estimated amount and delivery time per unit number of pages in the case of using each piece of equipment at each order-receiving company may be set in advance for each piece of equipment, and the estimate order-receiving conditions may be set from a busy/idle rank corresponding to the operating rate of equipment.

Specifically, for specific equipment that performs offset printing, the estimated amount and delivery time per unit number of pages are set as follows: 300 yen and 20 minutes for the busy/idle rank A; 250 yen and 18 minutes for the busy/idle rank B; 200 yen and 15 minutes for the busy/idle rank C; 150 yen and 13 minutes for the busy/idle rank D; and 100 yen and 10 minutes for the busy/idle rank E. Accordingly, the dynamic lead time fluctuation rate and the dynamic pricing fluctuation rate become unnecessary in the manageable-item information 7 illustrated in FIG. 5. The estimated amount and delivery time per unit number of pages of each piece of equipment that are associated with the busy/idle rank may be set by a person in charge at each order-receiving company through the person's order-receiving terminal 6.

However, it is sometimes difficult to grasp the correlation indicating to which values the estimated amount and delivery time per unit number of pages of each piece of equipment that are associated with such a busy/idle rank should be set, and furthermore, to which values the dynamic lead time fluctuation rate and the dynamic pricing fluctuation rate in the manageable-item information 7 in FIG. 5 should be set, in order to minimize variations in the operating status of each piece of equipment.

Therefore, the CPU 21 associatively stores the required specification in an order for printed matter, the delivery time and the estimated amount included in the estimate order-receiving conditions for each piece of equipment that are output to the order-placing company as the estimate order-receiving conditions for the order for the printed matter, the actual delivery time and the actually required amount for each piece of equipment that are required until the delivery of the printed matter by an order-receiving company in charge that has received an order-placing command for the order, and the operating rate of equipment at that time, and accumulates the associated pieces of information as accumulated information in the non-volatile memory 24. Moreover, the CPU 21 may set the estimated amount and delivery time per unit number of pages as well as the dynamic lead time fluctuation rate and the dynamic pricing fluctuation rate by calculating back from the optimal estimated amount and the optimal delivery time for the operating rate of each piece of equipment calculated so as to minimize the difference, at each operating rate, between the delivery time and the estimated amount output as the estimate order-receiving conditions to the order-placing company and the actual delivery time and the actually required amount that are required until the delivery of the printed matter by the order-receiving company in charge having received the order-placing command.

In addition, the CPU 21 may set the estimate order-receiving conditions by using a learning model trained on the basis of the accumulated information to output the optimal estimated amount and the optimal delivery time or the dynamic lead time fluctuation rate and the dynamic pricing fluctuation rate on receipt of, for example, the number of pages of to-be-processed printed matter, the type of equipment, and the operating rate of equipment.

### First Modification

In the above-described exemplary embodiment, even for orders with the same contents, the CPU 21 varies the estimate order-receiving condition(s) in accordance with the operating rate of each piece of equipment obtained from order-reception information of an already-confirmed received order. However, even if the operating rate of equipment is low at a time point at which the estimate order-receiving conditions are set, it is conceivable that there will be a day thereafter when orders are concentrated due to some external factors and the operating rate of equipment becomes high.

As above, although the operating rate of equipment is low at this moment, on receipt of an order from an order-placing company on a day in the future when the operating rate of equipment is expected to rise due to concentrated orders, if the CPU 21 receives the order by presenting to the order-placing company at least one of an estimated amount cheaper than the standard estimated amount and a delivery time shorter than the standard delivery time in order to minimize variations in the operating status of equipment at an order-receiving company just because the operating rate of equipment is low at the moment, this may result in an increase in variations in the operating status of each piece of equipment at the order-receiving company.

In order to avoid such situations, the CPU 21 may obtain information that influences the operating status of equipment (referred to as “external information”) from an external apparatus (not illustrated) connected to the communication line 2.

For example, the CPU 21 obtains, as external information, information on social situations from a news server that distributes news, as well as information on events in each local area from a local server that distributes information of each local area.

If, for example, news on a consumption tax increase is reported as information on social situations, it is expected that orders for printed matter will be concentrated before the tax increase, and the operating rate of equipment will rise. In contrast, it is expected that, for a certain period after the tax increase, it is expected that orders for printed matter will decrease compared to the average year, and the operating rate of equipment will decrease. Therefore, the CPU 21 may analyze the contents of news obtained from the news server by using a known technique and predict the future operating rate of each piece of equipment by additionally taking into consideration the operating rate of equipment at the moment and the degree of fluctuation of the operating rate of equipment due to changes in social situations.

Similarly, if it is reported that, as information on an event, a flea market will be held, the demand for leaflets tends to increase as the flea market will be held. Thus, it is expected that orders for printed matter will be placed before the flea market is held, resulting in an increase in the operating rate of equipment. Therefore, the CPU 21 may analyze the contents of local information obtained from the local server by using a known technique and predict the future operating rate of each piece of equipment by additionally taking into consideration the operating rate of equipment at the moment and the degree of fluctuation of the operating rate of equipment due to the holding of the event.

Furthermore, if the CPU 21 accumulates the daily operating rate of each piece of equipment in the non-volatile memory 24, a variation graph indicating changes in the daily operating rate of each piece of equipment on a yearly basis is obtained. The variation graph indicates the variation status of the operating rate of each piece of equipment due to seasonal factors. For example, the operating rate of each piece of equipment tends to vary in the same way every year if no sudden disaster occurs. Therefore, the CPU 21 may predict the future operating rate of each piece of equipment from information on seasons, such as the variation graph of the operating rate of each piece of equipment, and the operating rate of equipment at the moment. Since information on seasons is also information that influences the operating status of equipment, information on seasons is an example of external information.

The CPU 21 need not use all of information on social situations, information on events, and information on seasons in order to predict the future operating rate of each piece of equipment. The CPU 21 is only required to use any one of information on social situations, information on events, and information on seasons to predict the future operating rate of each piece of equipment, and may set the estimate order-receiving conditions by varying at least one of the estimated amount and the delivery time in accordance with the predicted operating rate of each piece of equipment.

### Second Modification

As has been described in the order receiving process in FIG. 11, in the process in step S150 in FIG. 11, the CPU 21 sets the quotation order-receiving conditions of the order-receiving company in charge in accordance with the latest operating rate of each piece of equipment at each order-receiving company, which is again obtained after the receipt of an order-placing command from the order-placing terminal 4. The estimate order-receiving conditions and the quotation order-receiving conditions have different times for obtaining the operating rate of equipment, which is used for setting the respective order-receiving conditions. The operating rate of equipment, which is used for setting the estimate order-receiving conditions of the order-receiving company in charge, is the operating rate of equipment obtained from the order-receiving terminal 6 at the order-receiving company in charge before the estimate order-receiving conditions are output to the order-placing terminal 4. The operating rate of equipment, which is used for setting the quotation order-receiving conditions, is the operating rate of equipment obtained from the order-receiving terminal 6 at the order-receiving company in charge after an order-placing command is received from the order-placing terminal 4.

Therefore, the longer the time required for a person in charge at an order-placing company to decide on the order-receiving company in charge, the longer the interval between the time for obtaining the operating rate of equipment used for setting the estimate order-receiving conditions and the time for obtaining the operating rate of equipment used for setting the quotation order-receiving conditions. If the interval between these times for obtaining the operating rate becomes longer, the order-receiving company in charge may possibly receive another order from another order-placing company via the information processing apparatus 10, and the operating rate of equipment may become different from that when the estimate order-receiving conditions are set. If the operating rate of equipment used for setting the estimate order-receiving conditions is different from that used for setting the quotation order-receiving conditions, it means that, even in the case of producing printed matter with the same required specification using the same equipment, the estimate order-receiving conditions and the quotation order-receiving conditions become different.

If the estimate order-receiving conditions and the quotation order-receiving conditions are different, for example, even in the case where the estimate order-receiving conditions include description that the order-receiving conditions may vary depending on the time of making an order-placing command, an inquiry may come from a person in charge at the order-placing company. This tendency becomes particularly strong in the case where the quotation order-receiving conditions become order-receiving conditions that are more unfavorable for the order-placing company than the estimate order-receiving conditions.

Therefore, before the receipt of an order-placing command from the order-placing company, the CPU 21 may receive information on an order-receiving company serving as a candidate for the order-receiving company in charge (referred to as a “temporary order-receiving company in charge”) among specific order-receiving companies from the order-placing company to which the estimate order-receiving conditions are presented. Because information on the temporary order-receiving company in charge, which is from the order-placing company, has the meaning as a temporary order that assures the information processing apparatus 10 to decide on the order-receiving company in charge among temporary order-receiving companies in charge and to transmit an order-placing command afterwards to the decided order-receiving company in charge, this information functions as a temporary order-placing command. Note that the number of temporary order-receiving companies in charge is not particularly limited, and there may be one or more temporary order-receiving companies in charge.

On receipt of a temporary order-placing command from the order-placing company, the CPU 21 performs exclusion control for not receiving orders for printed matter to the temporary order-receiving company in charge from other order-placing terminals 4 different from the order-placing terminal 4 having transmitted the temporary order-placing command until a predetermined period (referred to as a “temporary holding period”) elapses after the receipt of the temporary order-placing command.

Although the CPU 21 may set a period (such as ten minutes) stored in advance in the non-volatile memory 24 as the temporary holding period, the CPU 21 may set a period that is designated by the person in charge at the order-placing company within a predetermined range and that is transmitted along with a temporary order-placing command from the order-placing terminal 4 as the temporary holding period.

Since the temporary order-receiving company in charge receives no new orders for printed matter through the ordering system 1 over the temporary holding period, variations in the operating rate of equipment at the temporary order-receiving company in charge are suppressed, as compared to the case where no temporary holding period is set.

In addition, to suppress the difference between the estimate order-receiving conditions and the quotation order-receiving conditions, the CPU 21 may set the valid period of the estimate order-receiving conditions output to the order-placing terminal 4, and, if the valid period of the estimate order-receiving conditions expires before receiving an order-placing command from the order-placing terminal to which the estimate order-receiving conditions are output, may invalidate the estimate order-receiving conditions. Moreover, the CPU 21 executes the busy/idle status updating process illustrated in FIG. 9, and again outputs the new estimate order-receiving conditions set in accordance with the updated operating rate of equipment to the order-placing terminal 4. The CPU 21 also sets the valid period for the output of the new estimate order-receiving conditions.

When such control by the CPU 21 is seen from the order-placing terminal 4, for example, the estimate order-receiving conditions displayed on the order-placing terminal 4 are updated every time the valid period of the estimate order-receiving conditions expires.

Every time the valid period of the estimate order-receiving conditions expires, the CPU 21 may invalidate the estimate order-receiving conditions, and force the order-placing terminal 4 to which the estimate order-receiving conditions whose valid period has expired are output to log out from the ordering system 1. In this case, in order for the person in charge at the order-placing company to continuously make an order-placing command, the person operates the person's order-placing terminal 4 to again log in to the ordering system 1 and places an order for printed matter. Therefore, the new estimate order-receiving conditions set in accordance with the operating rate of equipment at the time of this second order are displayed on the screen of the order-placing terminal 4.

When such control is performed, the period from when the order-placing terminal 4 receives the latest estimate order-receiving conditions to when the order-placing terminal 4 transmits an order-placing command to the information processing apparatus 10 is limited to the period of the valid period. Therefore, as compared to the case where the estimate order-receiving conditions received first after placing an order for printed matter are continuously displayed on the screen of the order-placing terminal 4 until the person in charge at the order-placing company voluntarily updates the estimate order-receiving conditions again, the difference between the estimate order-receiving conditions and the quotation order-receiving conditions is suppressed.

When the CPU 21 displays, along with the estimate order-receiving conditions, warning information for warning that the estimate order-receiving conditions of the order-receiving company in charge and the quotation order-receiving conditions may be different on the screen of the order-placing terminal 4, if the estimate order-receiving conditions and the quotation order-receiving conditions have actually become different, the person who is making an order may be more convinced than the case where no warning information is displayed.

Therefore, in addition to each exemplary control performed by the CPU 21 discussed in the second modification, the CPU 21 may display warning information on the order-placing terminal 4.

Specifically, the CPU 21 outputs, along with the estimate order-receiving conditions, the number of persons in charge at order-placing companies who are browsing the estimate order-receiving conditions through their order-placing terminals 4 as warning information to the order-placing terminals 4. For example, the CPU 21 displays the message “Four other users are also browsing the website.” on the screen of the order-placing terminals 4.

In this case, a person in charge at an order-placing company who is trying to decide on the order-receiving company in charge becomes aware of the possibility that, because there are other companies trying to place an order for printed matter through the ordering system 1, if the person becomes late in making an order-placing command, the estimate order-receiving conditions may become different from the quotation order-receiving conditions. As a result, the person placing an order takes action to shorten the period from the receipt of the estimate order-receiving conditions at the order-placing terminal 4 to transmission of an order-placing command as much as possible. Thus, the effect that the difference between the estimate order-receiving conditions and the quotation order-receiving conditions is suppressed may be expected, as compared to the case where the number of persons browsing the estimate order-receiving conditions is not displayed on the screen of the order-placing terminal 4.

As the number of persons in charge at order-placing companies who are browsing the estimate order-receiving conditions, the number of order-placing terminals 4 that are logged in to the ordering system 1 and that have not yet transmitted an order-placing command to the information processing apparatus 10 after receiving the estimate order-receiving conditions from the information processing apparatus 10 may be used. Alternatively, the CPU 21 may express the number of persons in charge at order-placing companies who are browsing the estimate order-receiving conditions as the number of order-placing terminals 4 logged in to the ordering system 1.

Furthermore, if the estimate order-receiving conditions and the quotation order-receiving conditions become different, the CPU 21 may output the reason that the estimate order-receiving conditions and the quotation order-receiving conditions have become different to the order-placing terminal 4 to which the quotation order-receiving conditions different from the estimate order-receiving conditions have been output. For example, the CPU 21 displays a message such as “During the reception of an order-placing command, there were two new orders for the printing company to which the order has been placed, and the amount to be paid has become higher than the estimated amount.” on the screen of the order-placing terminal 4.

In addition, the CPU 21 may display, along with a screen displaying the quotation order-receiving conditions on the order-placing terminal 4, a message exchange field for allowing the person in charge at the order-placing company and the person in charge at the order-receiving company in charge to exchange messages for describing why the estimate order-receiving conditions and the quotation order-receiving conditions have become different or for negotiating the price.

So far, an example in which, every time the valid period of the estimate order-receiving conditions expires, the estimate order-receiving conditions output from the information processing apparatus 10 to the order-placing terminal 4 are updated in accordance with the operating rate of each piece of equipment at each order-receiving company after the expiration.

In this case, even if the operating rate of each piece of equipment at an order-receiving company determined by the person placing an order as the order-receiving company in charge varies within the valid period, if the CPU 21 receives an order-placing command from the order-placing terminal 4 within the valid period of the estimate order-receiving conditions, the CPU 21 may execute step S160 without executing steps S140 and S150 in FIG. 11, and, output the immediately preceding estimate order-receiving conditions displayed on the order-placing terminal 4 before receiving the order-placing command as they are as the quotation order-receiving conditions to the order-placing terminal 4 having transmitted the order-placing command.

That is, no matter when the CPU 21 receives an order-placing command from the order-placing terminal 4, if the reception is within the valid period of the estimate order-receiving conditions, the CPU 21 makes a commitment that the order-receiving company in charge receives the order for printed matter with the estimate order-receiving conditions within the valid period displayed on the order-placing terminal 4. Accordingly, the estimate order-receiving conditions of the order-receiving company in charge and the quotation order-receiving conditions of the order-receiving company in charge become the same order-receiving conditions.

Although one aspect of the information processing apparatus 10 in the ordering system 1 has been described using the exemplary embodiment, the disclosed mode of the information processing apparatus 10 is only exemplary, and the mode of the information processing apparatus 10 is not limited to the scope described in the exemplary embodiment. Various changes or improvements may be made to the exemplary embodiment without departing from the gist of the present disclosure, and the changed or improved modes are also included in the technical scope of the disclosure. For example, the order of the busy/idle status updating process illustrated in FIG. 9 and the order receiving process illustrated in FIG. 11 may be changed without departing from the gist of the present disclosure.

In the above-described exemplary embodiment, the mode in which the busy/idle status updating process and the order receiving process are implemented by software has been described by way of example. However, processes equivalent to the flowcharts illustrated in FIGS. 9 and 11 may be processed by hardware. In this case, the processing speed is increased, as compared to the case where the busy/idle status updating process and the order receiving process are implemented by software.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Although the example in which the information processing program is stored in the ROM 22 has been described in the above-described exemplary embodiment, the storage destination of the information processing program is not limited to the ROM 22. The information processing program of the present disclosure may be provided by being recorded in a storage medium readable by the computer 20. For example, a matching program may be provided by being recorded in an optical disc such as a compact disc read-only memory (CD-ROM) or a digital versatile disc read-only memory (DVD-ROM). Alternatively, the information processing program may be provided by being recorded in portable semiconductor memory such as a Universal Serial Bus (USB) flash drive and a memory card. The ROM 22, the non-volatile memory 24, a CD-ROM, a DVD-ROM, a USB flash drive, and a memory card are examples of a non-transitory storage medium.

Furthermore, the information processing apparatus 10 may download the information processing program from an external apparatus (not illustrated) connected to the communication line 2 by using the communication unit 27, and store the downloaded information processing program in a storage device. In this case, the CPU 21 of the information processing apparatus 10 loads the information processing program, which has been downloaded from the external apparatus (not illustrated), from the storage device, and executes the busy/idle status updating process and the order receiving process.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
obtain an index value representing an operating status of a production facility for a product at each of a plurality of order-receiving companies registered in advance as candidates for a contractor for production of the product;
for each order-receiving company, set an order-receiving condition of at least one of an estimated amount and a delivery time for production of the product in accordance with the index value; and
output estimate order-receiving conditions of each order-receiving company, which include the order-receiving condition, to an order-placing terminal used by a person in charge at a company that places an order for the product.

2. The information processing apparatus according to claim 1, wherein, for each order-receiving company, the processor is configured to set the order-receiving condition by varying, in accordance with a magnitude of the index value, at least one of a standard estimated amount of the product set from a manufacturing cost of the product and a standard delivery time of the product set from a processing capacity of the production facility for the product, each of the standard estimated amount and the standard delivery time being set irrespective of the operating status of the production facility for the product.

3. The information processing apparatus according to claim 2, wherein the processor is configured to perform at least one of control for varying an estimated amount of the product to be higher than the standard estimated amount of the product as an operating rate of the production facility for the product becomes higher, and control for varying a delivery time of the product to be longer than the standard delivery time of the product as an operating rate of the production facility for the product becomes higher.

4. The information processing apparatus according to claim 1, wherein the processor is configured to use at least one of an estimated amount and a delivery time for production of the product to be set as the order-receiving condition, the estimated amount and the delivery time being associated in advance with the index value.

5. The information processing apparatus according to claim 1, wherein the index value is a value that reflects both an operating status of the production facility involved in producing the product for which an order has been received by each order-receiving company using the information processing apparatus, and an operating status of the production facility involved in producing the product for which an order has been received by each order-receiving company without using the information processing apparatus.

6. The information processing apparatus according to claim 2, wherein the index value is a value that reflects both an operating status of the production facility involved in producing the product for which an order has been received by each order-receiving company using the information processing apparatus, and an operating status of the production facility involved in producing the product for which an order has been received by each order-receiving company without using the information processing apparatus.

7. The information processing apparatus according to claim 3, wherein the index value is a value that reflects both an operating status of the production facility involved in producing the product for which an order has been received by each order-receiving company using the information processing apparatus, and an operating status of the production facility involved in producing the product for which an order has been received by each order-receiving company without using the information processing apparatus.

8. The information processing apparatus according to claim 4, wherein the index value is a value that reflects both an operating status of the production facility involved in producing the product for which an order has been received by each order-receiving company using the information processing apparatus, and an operating status of the production facility involved in producing the product for which an order has been received by each order-receiving company without using the information processing apparatus.

9. The information processing apparatus according to claim 1, wherein the processor is configured to:
further obtain external information, which is information other than order-receiving information of the product at each order-receiving company and which influences the operating status of the production facility for the product; and
vary the order-receiving condition using the index value and the external information.

10. The information processing apparatus according to claim 9, wherein the external information includes at least one of information on a social situation, information on an event, and information on a season.

11. The information processing apparatus according to claim 1, wherein the processor is configured to:
obtain, from the order-placing terminal, information on an order-receiving company in charge requested to produce the product, the order-receiving company in charge being selected by a person placing an order for the product from among the order-receiving companies whose estimate order-receiving conditions are presented; and
perform control for making quotation order-receiving conditions of the order-receiving company in charge closer to the estimate order-receiving conditions of the order-receiving company in charge, the quotation order-receiving conditions using the order-receiving condition varied in accordance with the index value of the order-receiving company in charge after information on the order-receiving company in charge is obtained.

12. The information processing apparatus according to claim 11, wherein, on receipt of, from the order-placing terminal, information that designates, among the order-receiving companies whose estimate order-receiving conditions are presented, at least one order-receiving company as a candidate for the order-receiving company in charge, the processor is configured to not receive, over a predetermined period, a production request for the product for the order-receiving company designated as the candidate for the order-receiving company in charge from another order-placing terminal different from the order-placing terminal from which the candidate for the order-receiving company in charge has been obtained.

13. The information processing apparatus according to claim 11, wherein, in a case where no information on the order-receiving company in charge is received from the order-placing terminal even after a predetermined period elapses since the estimate order-receiving conditions are output to the order-placing terminal, the processor is configured to invalidate the estimate order-receiving conditions of each order-receiving company, which are output to the order-placing terminal.

14. The information processing apparatus according to claim 11, wherein the processor is configured to output warning information for warning that the estimate order-receiving conditions and the quotation order-receiving conditions may be different to the order-placing terminal.

15. The information processing apparatus according to claim 14, wherein the processor is configured to output, as the warning information, a number of persons browsing the estimate order-receiving conditions through their order-placing terminals to each of the order-placing terminals.

16. The information processing apparatus according to claim 11, wherein, in a case where the estimate order-receiving conditions and the quotation order-receiving conditions are different, the processor is configured to output a reason that the estimate order-receiving conditions and the quotation order-receiving conditions are different to the order-placing terminal to which the quotation order-receiving conditions different from the estimate order-receiving conditions are output.

17. The information processing apparatus according to claim 11, wherein, until a predetermined period elapses since the estimate order-receiving conditions are output to the order-placing terminal, the processor is configured to set the estimate order-receiving conditions of the order-receiving company in charge, which are output to the order-placing terminal, as the quotation order-receiving conditions of the order-receiving company in charge, even in a case where the index value of the order-receiving company in charge varies within the predetermined period.

18. The information processing apparatus according to claim 1, wherein the processor is configured to obtain the index value in units of pieces of equipment constituting the production facility for the product.

19. The information processing apparatus according to claim 18, wherein the processor is configured to adjust the index value of the equipment by multiplying the index value by a coefficient associated in advance with the equipment, and vary the order-receiving condition in accordance with a magnitude of the adjusted index value.

20. A non-transitory computer readable medium storing a program causing a computer to execute a process, the process comprising:
obtaining an index value representing an operating status of a production facility for a product at each of a plurality of order-receiving companies registered in advance as candidates for a contractor for production of the product;
for each order-receiving company, setting an order-receiving condition of at least one of an estimated amount and a delivery time for production of the product in accordance with the index value; and
outputting estimate order-receiving conditions of each order-receiving company, which include the order-receiving condition, to an order-placing terminal used by a person in charge at a company that places an order for the product.
